(19) United States
(12) Patent Application Publication
(10) Pub. No.: US 2022/0248742 A1
(43) Pub. Date: Aug. 11, 2022

(54) WHIPPED CREAM MACHINE

(71) Applicant: MANITOWOC FOODSERVICE COMPANIES, LLC, New Port Richey, FL (US)

(72) Inventors: John A. Broadbent, Tampa, FL (US); Daryl G. Erbs, Tarpon Springs, FL (US); Jonathan Joseph Bown, Tampa, FL (US)

(73) Assignee: MANITOWOC FOODSERVICE COMPANIES, LLC, New Port Richey, FL (US)

(21) Appl. No.: 17/583,731

(22) Filed: Jan. 25, 2022

Related U.S. Application Data
(60) Provisional application No. 63/147,366, filed on Feb. 9, 2021.

(51) Int. Cl. A23P 30/40; A23C 13/12

(52) U.S. Cl. CPC A23P 30/40; A23C 2210/30; A23C 13/12

(57) ABSTRACT

A whipped cream machine includes a source of whipping cream, a source of gas, a mixing portion connected to the source of whipping cream and the source of gas to form a whipping cream and gas mixture at an elevated pressure that is a whipped cream, an expansion device to relieve the pressure and expand the gas in the whipped cream to form expanded whipped cream that has been expanded to the desired overrun, and a dispenser to dispense the expanded whipped cream.

### CROSS REFERENCE TO RELATED APPLICATIONS

This application claims the benefit of U.S. Provisional Application 63/147,366 filed Feb. 9, 2021, the contents of which are incorporated by reference herein.

### BACKGROUND OF THE DISCLOSURE

### 1. Field of the Disclosure

The present disclosure is directed to making whipped cream. More particularly, the present disclosure relates to a whipped cream machine that utilizes pressurized fluid (gas and/or cream) to produce whipped cream.

### 2. Description of the Related Art

The traditional way to make whipped cream is by mixing whipping cream in a mixing bowl with an electric hand mixer or a stand mixer. The whipped cream formed in the mixing bowl has excellent, long-lasting body and has an overrun of about 100 percent. Overrun is the percent increase in volume relative to the initial volume of whipping cream. 100 percent overrun means there is twice as much volume of whipped cream as there was volume of whipping cream initially, with the additional volume coming from the entrainment of a gas, air in this case, into the whipping cream. Compared to higher overrun whipped cream, such as whipped cream made using nitrous oxide which can have an overrun in excess of 300%, whipped cream having 100 percent overrun has a relatively high calorie and fat content. Whipped cream having 100 percent overrun is more expensive, too, since it takes more whipping cream to make a given volume of whipped cream. Moreover, whipped cream made using nitrous oxide transforms into a watery substance after a brief period which can be undesirable.

Whipped cream dispensers that use nitrous oxide dispense higher overrun whipped cream than whipped cream made in the mixing bowl. Nitrous oxide makes whipped cream by dissolving into the whipping cream under pressure then coming out of solution and creating whipped cream “foam” when the pressure is released. It essentially foams the whipping cream the same way that foam forms on carbonated beverages. This foaming mechanism can produce higher overrun whipped cream, in excess of 300%, than is possible with mechanical mixing alone. This higher overrun gives the whipped cream a lower calorie and fat content and a lower cost per unit of volume. However, nitrous oxide (N₂O) is a greenhouse gas that is harmful to the environment. Nitrous oxide is also used as a recreational drug, so it presents an abuse and theft risk.

Canned whipped cream has the highest overrun of the whipped cream types discussed above. It can have an overrun of about 400 percent, giving it the lowest calorie and fat content per unit volume. However canned whipped cream also uses nitrous oxide (N₂O), a greenhouse gas that is harmful to the environment.

Accordingly, there is a need for a method and a device to make whipped cream that overcomes the disadvantages described above. In particular, there is a need for a whipped cream machine that eliminates the use of nitrous oxide that is harmful to the environment and presents an abuse and theft risk. There is also a need for a machine that produces high overrun whipped cream so that the cost and calorie content of the whipped cream is competitive with that made with nitrous oxide.

### SUMMARY OF THE DISCLOSURE

In multiple embodiments of the present disclosure there is provided a whipped cream machine that includes a source of whipping cream, a source of gas, a mixing portion connected to the source of whipping cream and the source of gas to form a pressurized whipping cream and gas mixture that is a whipped cream, and an expansion device that allows the gas in the whipped cream to expand so that the expanded whipped cream that results has the desired overrun, and a dispenser to dispense the expanded whipped cream.

The above and other objects, features, and advantages of the present disclosure will be apparent and understood by those skilled in the art from the following detailed description, drawings, and accompanying claims. As shown throughout the drawings, like reference numerals designate like or corresponding parts.

### BRIEF DESCRIPTION OF THE DRAWINGS

FIG. 1 is a front perspective view of a whipped cream machine according to the present disclosure.

FIG. 2 is a schematic view of a first embodiment of a mixing portion connected to a dispensing tower/whipped cream expansion chamber of the whipped cream machine of FIG. 1.

FIG. 3a is a cross sectional view of a first embodiment of the dispensing tower/whipped cream expansion chamber of the whipped cream machine of FIG. 1 in a fill position.

FIG. 3b is a cross sectional view of the dispensing tower/whipped cream expansion chamber of FIG. 3a in a filled position.

FIG. 3c is a cross sectional view of the dispensing tower/whipped cream expansion chamber of FIG. 3a in an expanded position.

FIG. 3d is a cross sectional view of the dispensing tower/whipped cream expansion chamber of FIG. 3a in a dispense position.

FIG. 4 is a schematic view of a second embodiment of the mixing portion connected to the dispensing tower/whipped cream expansion chamber of the whipped cream machine of FIG. 1.

FIG. 5a is a cross sectional view of a second embodiment of the dispensing tower/whipped cream expansion chamber of the whipped cream machine of FIG. 1 in a fill position.

FIG. 5b is a cross sectional view of the dispensing tower/whipped cream expansion chamber of FIG. 5a in a filled position.

FIG. 5c is a cross sectional view of the dispensing tower/whipped cream expansion chamber of FIG. 5a in an expanded position.

FIG. 5d is a cross sectional view of the dispensing tower/whipped cream expansion chamber of FIG. 5a in a dispense position.

FIG. 6a is a cross sectional view of a third embodiment of the dispensing tower/whipped cream expansion chamber of the whipped cream machine of FIG. 1 in a fill position.

FIG. 6b is a cross sectional view of the dispensing tower/whipped cream expansion chamber of FIG. 6a in a filled position.

FIG. 6c is a cross sectional view of the dispensing tower/whipped cream expansion chamber of FIG. 6a in an expanded position.

FIG. 6d is a cross sectional view of the dispensing tower/whipped cream expansion chamber of FIG. 6a in a dispense position.

FIG. 7a is a cross sectional view of a fourth embodiment of the dispensing tower/whipped cream expansion chamber of the whipped cream machine of FIG. 1 in a fill position.

FIG. 7b is a cross sectional view of the dispensing tower/whipped cream expansion chamber of FIG. 7a in a filled position.

FIG. 7c is a cross sectional view of the dispensing tower/whipped cream expansion chamber of FIG. 7a in an expanded position.

FIG. 7d is a cross sectional view of the dispensing tower/whipped cream expansion chamber of FIG. 7a in a dispense position.

FIG. 8a is a cross sectional view of a fifth embodiment of the dispensing tower/whipped cream expansion chamber of the whipped cream machine of FIG. 1 in a first position.

FIG. 8b is a cross sectional view of the dispensing tower/whipped cream expansion chamber of FIG. 8a in a second position.

FIG. 8c is a cross sectional view of the dispensing tower/whipped cream expansion chamber of FIG. 8a in a third position.

### DETAILED DESCRIPTION OF THE DISCLOSURE

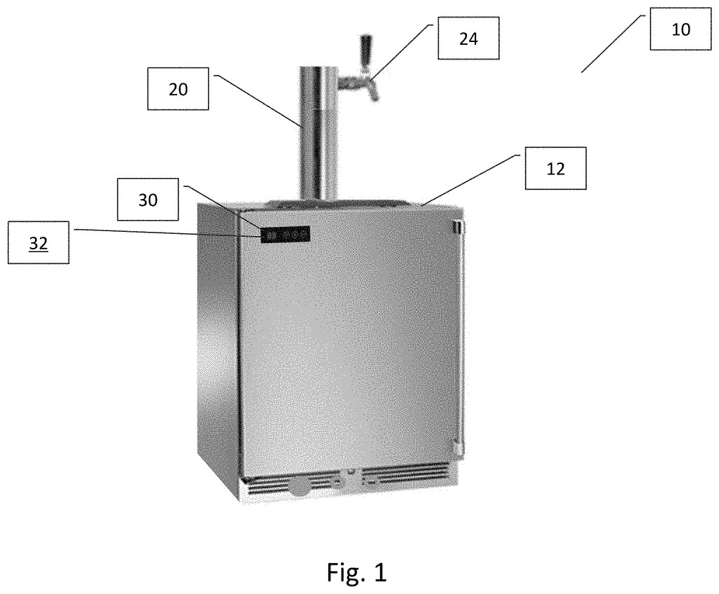

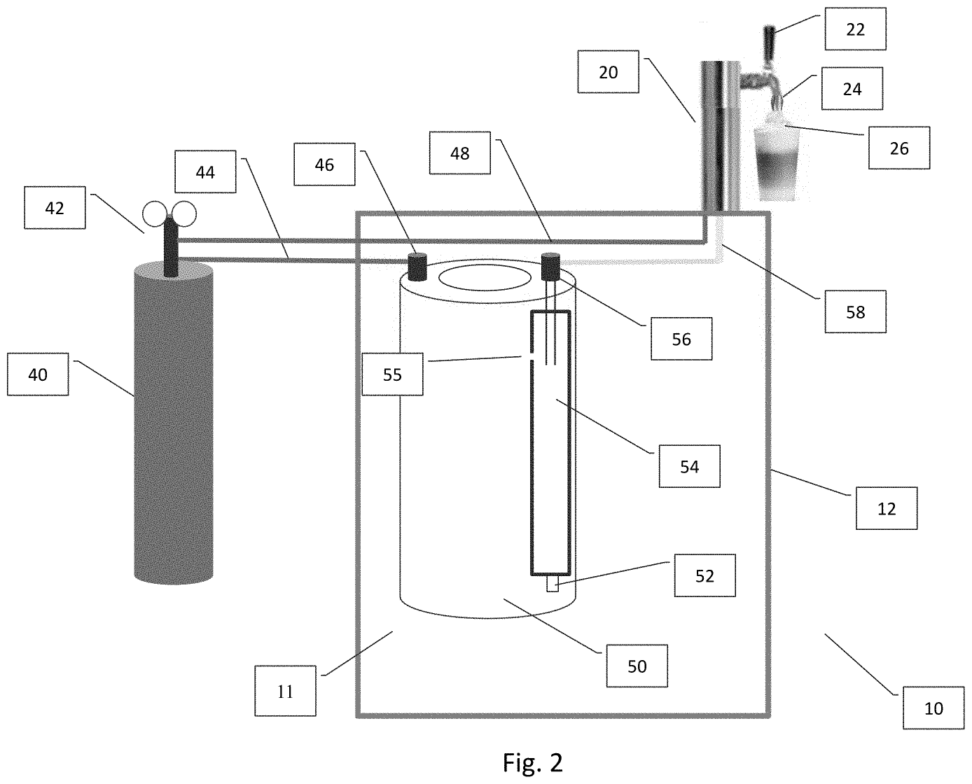

A whipped cream machine generally represented by reference numeral 10 of the present disclosure is shown in FIG. 1 (“machine 10”). Machine 10 produces high-overrun whipped cream without the use of nitrous oxide; a greenhouse gas which is harmful to the environment, and which can present an abuse and theft risk. Machine 10 has a refrigerated compartment 12 and a dispensing tower/whipped cream expansion chamber 20. Dispensing tower/whipped cream expansion chamber 20 has a dispensing tap 24 for dispensing whipped cream. The machine 10 is connected to a source of electricity and a source of compressed gas 40 (shown in FIG. 2). Depending on the features included, machine 10 can also be connected to a source of water and a drain (neither shown) for cleaning purposes. Machine 10 can serve as a countertop whipped cream machine or the refrigerator portion can be physically separated from the dispensing tower for more optimal placement in a commercial establishment.

Also shown in FIG. 1 is a display screen 30. Display screen 30 is used to display, for example, status information for machine 10 such as whipping cream temperature, whipping cream level, gas pressure, whipping cream expiration date, lock-out status (e.g., if temperature limits or whipping cream expiration date exceeded). Display screen 30 can communicate with a controller 32 shown schematically in FIG. 1 that communicates with one or more sensors that detect the status information in machine 10 for display by display screen 30.

FIG. 2 is a schematic view of a first embodiment of a mixing portion 11 of machine 10. The purpose of mixing portion 11 is to combine the whipping cream and a gas in a way that creates a mechanically whipped gas and cream mixture or emulsion with 100-150% overrun at a relatively high pressure. In this embodiment, a source of compressed gas 40 supplies gas (e.g., nitrogen or compressed air) through pressure regulator 42 then through line 44 into beverage keg inlet connection 46 and into beverage keg 50. Beverage keg 50 contains whipping cream and is pressurized by this supplied gas from source of compressed gas 40. The pressurization allows the whipping cream to be pushed out of beverage keg 50 through inlet 52 into mixing device 54. Gas is also allowed to enter mixing device 54 through gas inlet 55. Mixing device 54 causes the gas flowing in through inlet 55 to be mixed with the flow of the whipping cream entering through inlet 52 forming a whipping cream and gas mixture. Mixing device 54 is, for example, a device of the type shown in U.S. Pat. No. 3,815,789 to Carpigiani that is hereby incorporated by references in its entirety. After passing through device 54, the whipping cream and gas mixture is effectively whipped cream. The whipped cream exits beverage keg 50 through outlet connection 56 and into cream line 58.

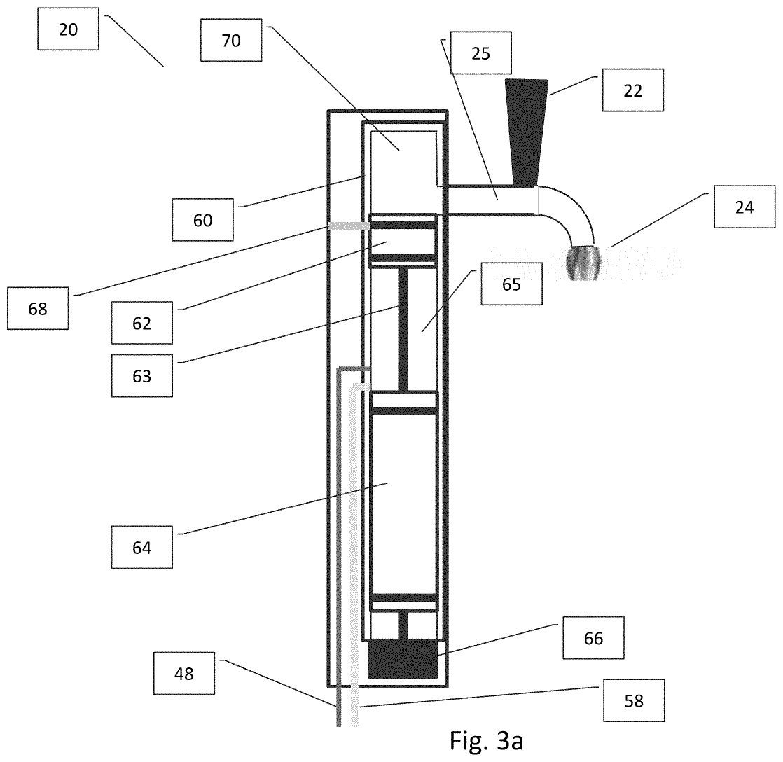

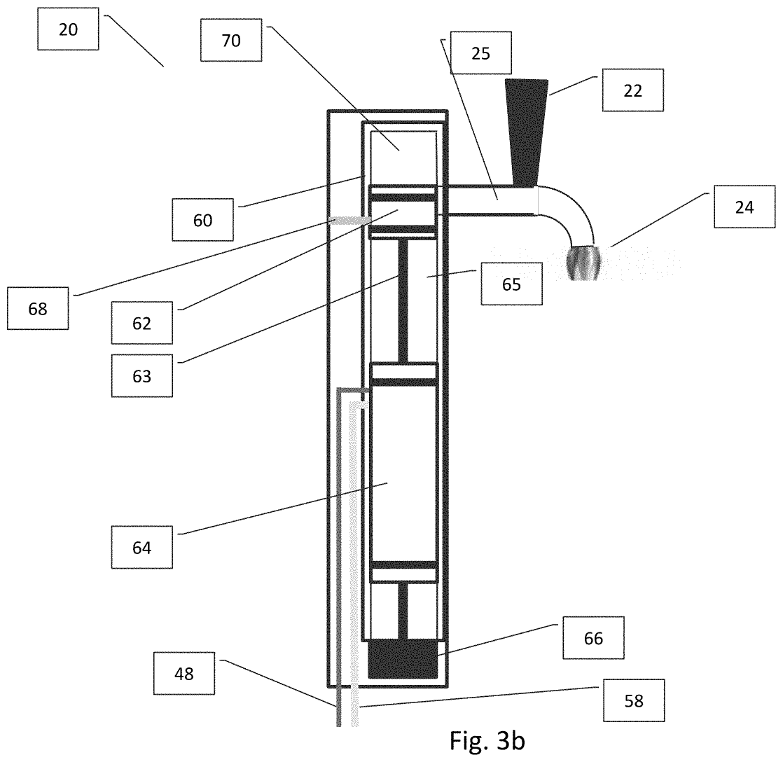

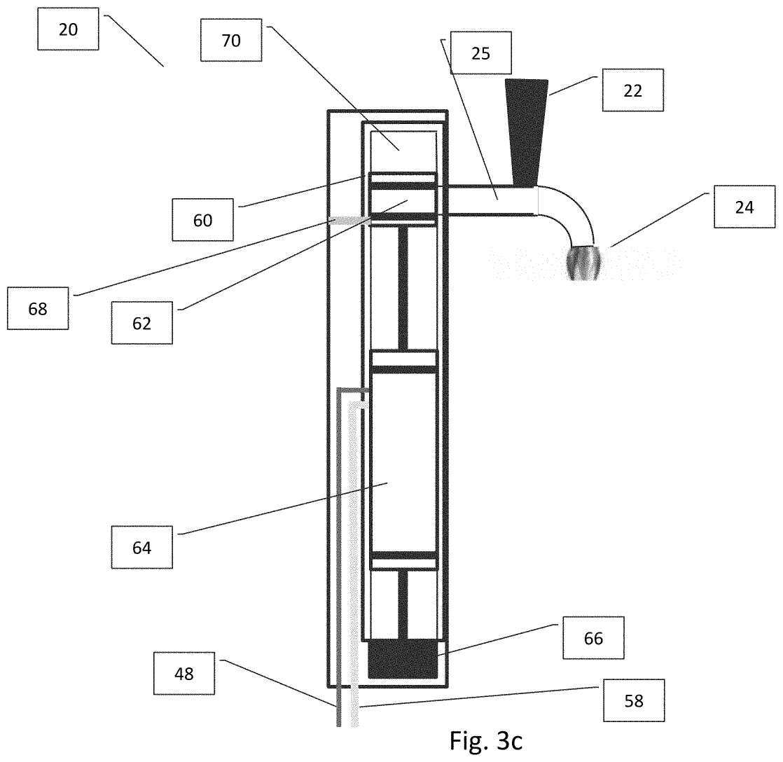

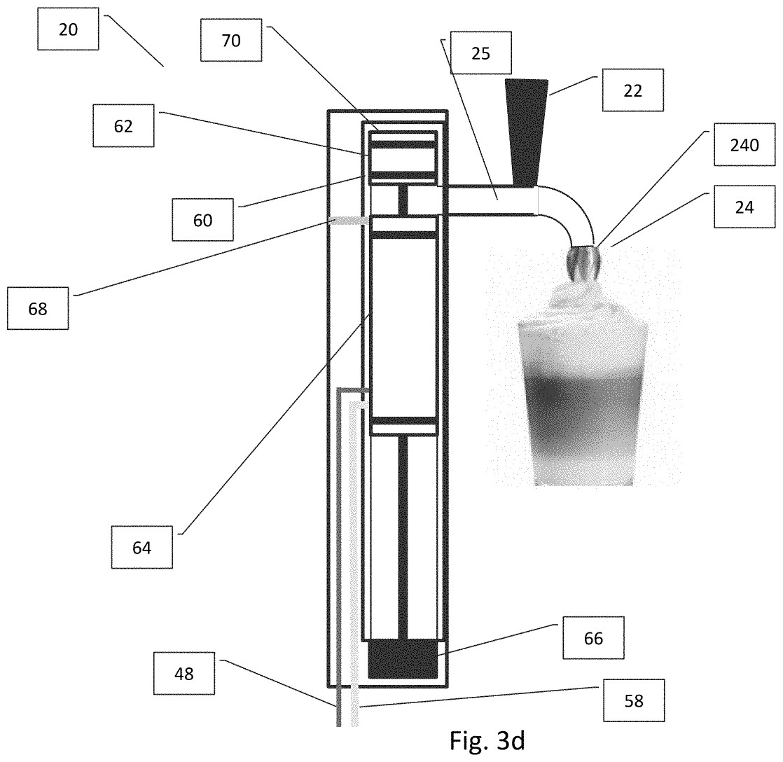

FIG. 3a is a cross section of a first embodiment of dispensing tower/whipped cream expansion chamber 20. This component is the key to creating high-overrun whipped cream without using nitrous oxide. It is designed to slowly release the pressure under which the whipped cream from beverage keg 50 was formed. Relieving this pressure causes the gas bubbles in the whipped cream to expand consistent with Boyle's law. That is, at a constant temperature, pressure and volume are inversely related. By decreasing the pressure of the whipped cream from, for example, 30 psig (^{˜}45 psia) to 0 psig (^{˜}15 psia), the pressure is decreased by a factor of 3. This results in the air bubbles in the whipped cream to expand by a factor of 3. If the whipped cream starts with an overrun of 100% (meaning the volume of bubbles is equal to the initial volume of the whipped cream), when expanded by a factor of 3 the whipped cream will end up with an overrun of 300% (only the bubbles can expand—the cream does not expand). This expansion must be done in a controlled manner. If the pressure is released too suddenly, it causes the gas bubbles in the whipped cream to burst and precludes the creation of high-overrun whipped cream.

The first embodiment of dispensing tower/whipped cream expansion chamber 20 shown in FIG. 3a includes a cylinder 60 containing an upper piston 62 and a lower piston 64 connected to each other by rod 63. The two pistons create a chamber 65 between them. During operation, as shown in FIG. 3b, chamber 65 is pressurized by gas from gas line 48 and allowed to fill with the whipped cream from cream line 58. Note that the pressure of the gas coming from gas line 48 must be at a lower pressure than that in line 44. The desired pressure from gas line 48 is, for example, 30 psig. The pressure in line 44 must be higher than that to drive the whipping cream from beverage keg 50, through mixing device 54 and the whipped cream into chamber 65. The pressure differential must be enough to push the whipping cream through mixing device 54 such that it provides the proper amount of mixing. This pressure differential depends on the exact design of mixing device 54 and the amount of mixing desired. The pressure differential will vary between 10 psi and 60 psi.

When chamber 65 is half-filled with the whipped cream, stepper motor 66 is energized to move upper piston 62 and lower piston 64 upward. This movement of upper piston 62 and lower 64 causes gas line 48 and cream line 58 to be closed by the position of lower piston 64, as shown in FIG. 3b. To expand the whipped cream upper piston 62 and lower 64 can be moved up further such that vent 68 is opened to chamber 65 by the position of upper piston 62. As shown in FIG. 3c, these changes allow the pressure of the gas in chamber 65 to be vented to atmospheric through vent 68, causing the whipped cream to inflate to 300% overrun as explained previously forming an expanded whipped cream.

Upper piston 62 and lower piston 64 then continue traveling upward, powered by stepper motor 66. The piston assembly that includes upper piston 62, connecting rod 63 and lower piston 64 are designed to constrain upper piston 62 and lower piston 64 from moving further apart (this allows upper piston 62 and lower piston 64 to hold pressure) but upper piston 62 and lower piston 64 are free to move closer together. As upper piston 62 reaches an upward-most position 70, it stops moving and lower piston 64 keeps moving upward. As shown in FIG. 3d, this causes upper piston 62 and lower piston 64 to move towards each other, squeezing the expanded whipped cream and pushing it out through passageway 25 and dispensing tap 24. Dispensing tap 24 must include passageway 25 and an orifice 240 that is a large enough size so not to cause the gas that form bubbles inside of the expanded whipped cream to burst, for example larger than ¼″ in diameter.

Once all the expanded whipped cream has been squeezed out from between upper piston 62 and lower piston 64, or the desired amount of the expanded whipped cream has been dispensed, the upward movement of the lower piston 64 is reversed. This moves upper piston 62 and lower piston 64 back into their starting position so that chamber 65 can refill as shown in FIG. 3a. Note that gas pressure from line 58 forces upper piston 62 and lower piston 64 to be pushed apart, making room for the next batch of whipped cream.

Alternatively, by stopping upper piston 62 and lower piston 64 after closing off gas line 48 and cream line 58 and positioning chamber 65 so it can vent through vent 68, as shown in FIG. 3c, but before chamber 65 is in position to dispense, it is possible to hold and store the expanded whipped cream that is inside chamber 65. The expanded whipped cream can remain inside chamber 65 until a user needs to dispense the expanded whipped cream from machine 10. Accordingly, after dispensing the expanded whipped cream, machine 10 can fill chamber 65 with the whipped cream, as shown in FIG. 3b, and inflate the whipped cream to form the expanded whipped cream, as shown in FIG. 3c, so that machine 10 is ready for the next dispense at a future time.

Not shown in any of the figures is the refrigeration system needed to keep the entire dispensing tower/whipped cream expansion chamber 20 at a low enough temperature to satisfy the National Sanitation Foundation (“NSF”) requirements (41 degrees Fahrenheit for systems that dispense milk-based products). The refrigeration system can be a refrigerated cabinet that surrounds dispensing tower/whipped cream expansion chamber 20 to cool dispensing tower/whipped cream expansion chamber 20 with cool air. Another refrigeration system can include refrigeration lines that circulates a cooling fluid, for example, refrigerant or ethylene glycol, that are in thermal communication with dispensing tower/whipped cream expansion chamber 20 to cool dispensing tower/whipped cream expansion chamber 20.

Note that in FIG. 3a tap handle 22 is not connected to a mechanical valve as it would normally. Rather it would be connected to an electronic switch used to initiate motion of stepper motor 66 and upper piston 62 and lower piston 64.

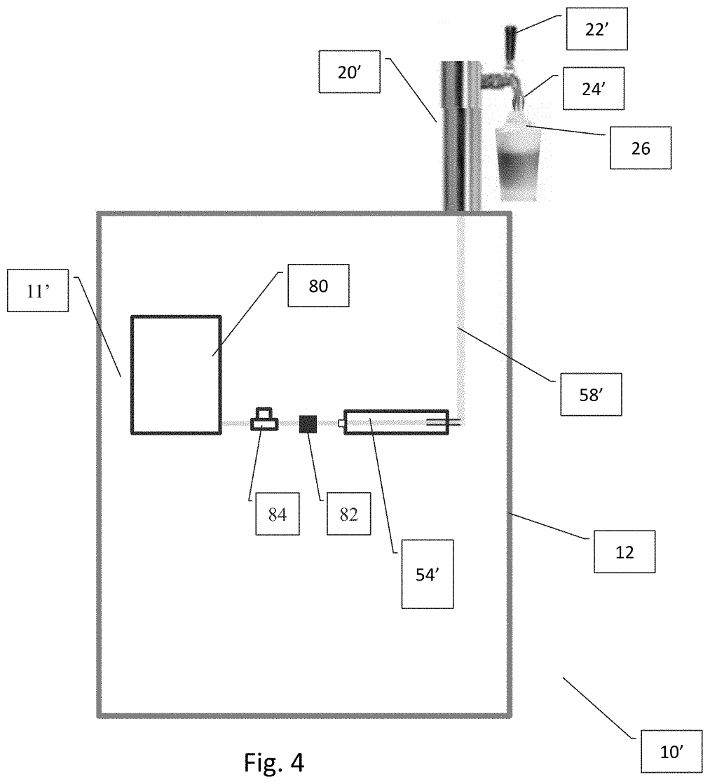

FIG. 4 shows a schematic view of a second embodiment of a mixing portion 11′ of whipped cream machine 10′. The beverage keg, or alternatively, a bag-in-box 80 (a collapsible plastic bag of whipping cream inside a cardboard box) is connected to a pump 82 that is used to draw the whipping cream through a fluid line that contains a venturi 84 that is an air inlet venturi. Venturi 84 causes air to be entrained into a stream of the whipping cream as it is drawn into pump 82. From pump 82, the whipping cream/air mixture is forced through a mixing device 54′ that is the same as mixing device 54. As it leaves the mixing device 54′, the whipping cream/air mixture has become whipped cream with an overrun of 100-150% and is at a higher than ambient pressure, for example ^{˜}30 psig. The whipped cream then passes through cream line 58′ that is the same as cream line 58 into a second embodiment of a dispensing tower/whipped cream expansion chamber 20′.

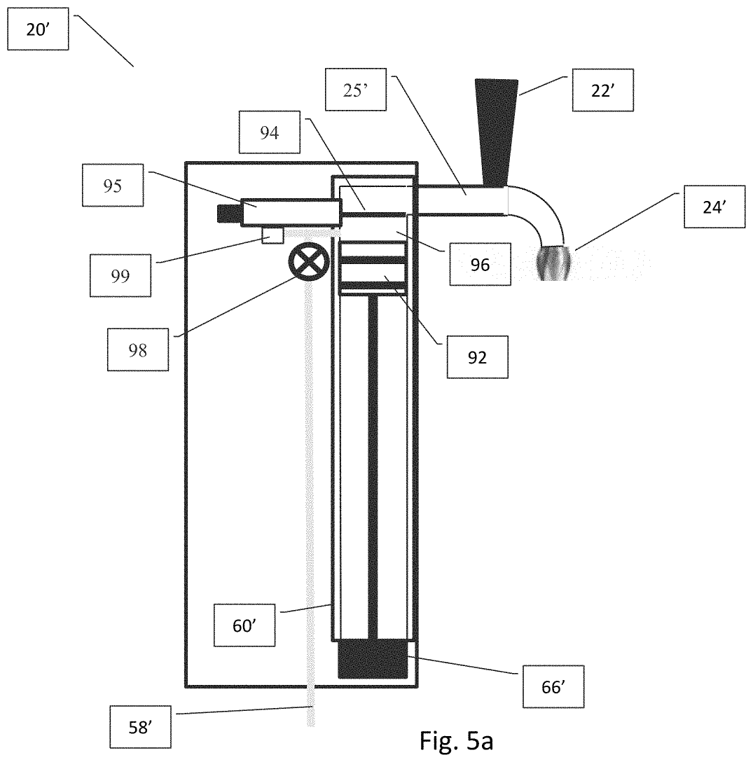

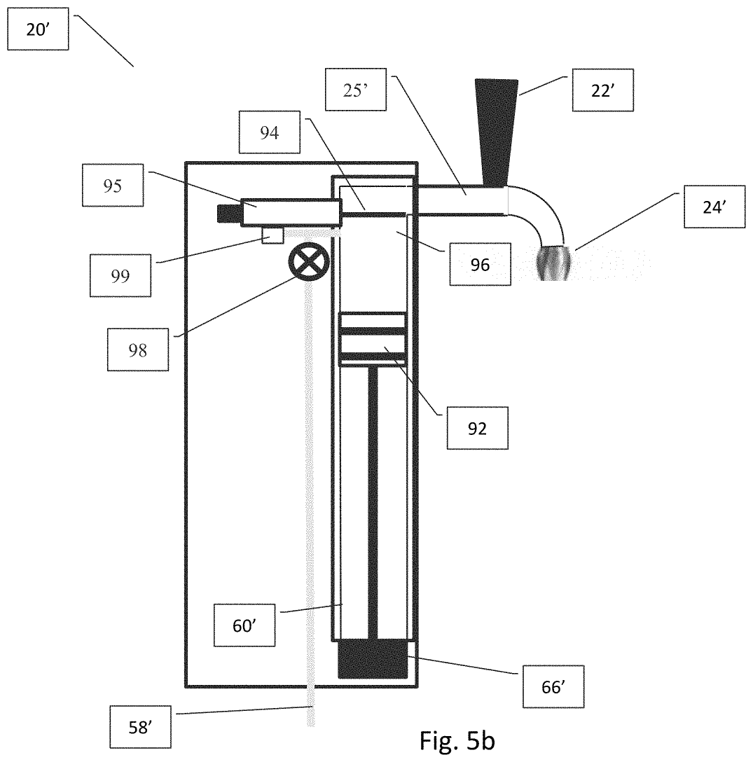

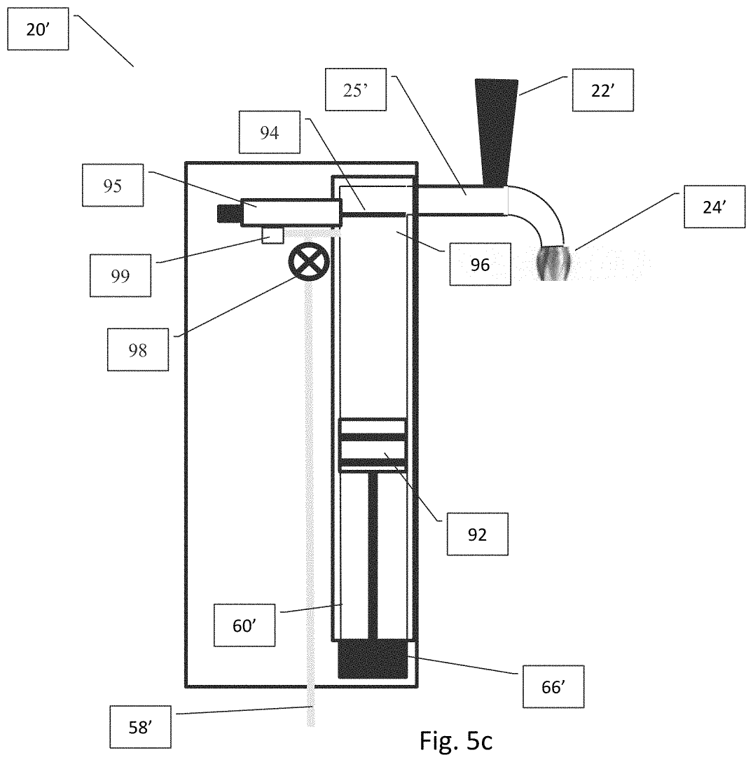

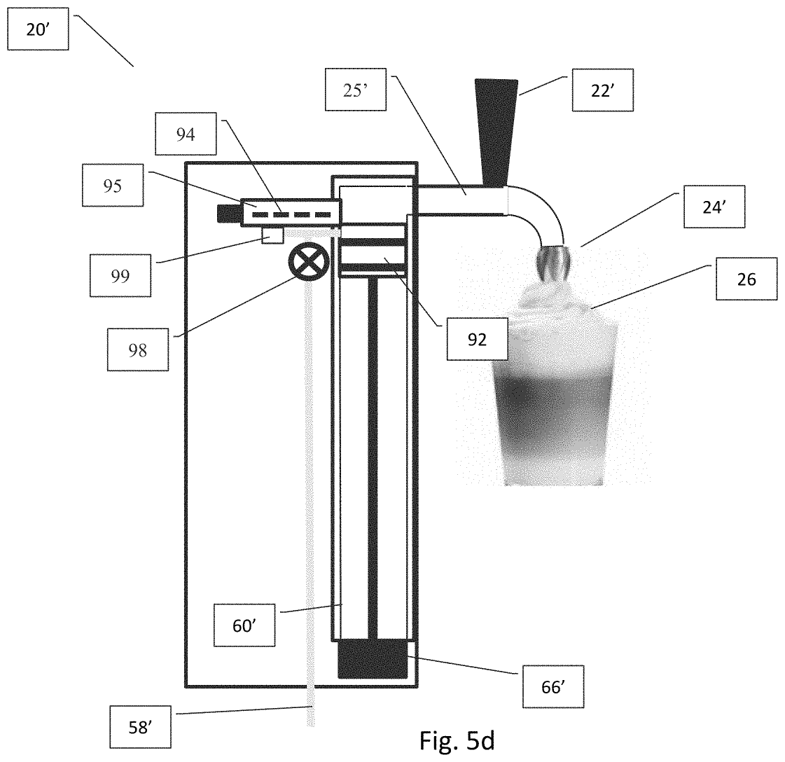

FIGS. 5a through 5d show a second embodiment of a dispensing tower/whipped cream expansion chamber 20′ illustrating its operation. FIG. 5a shows a chamber 96 that is an expansion chamber prior to filling. Dispensing tower/whipped cream expansion chamber 20′ includes whipped cream line 58′, a cylinder 60′, a stepper motor 66′, a piston 92, a gate 94, a gate valve mechanism 95, a whipped cream solenoid valve 98 and a pressure sensor 99. Cylinder 60′ is the same as cylinder 60. Stepper motor 66′ is the same as stepper motor 66. When dispensed, the whipped cream will travel through passageway 25′ and exit through dispensing tap 24′ upon actuation of tap handle 22′ that are the same as handle 22, passageway 25 and dispensing tap 24 of machine 10.

In the beginning of a fill sequence, piston 92 is located next to gate 94 as shown in FIG. 5a. Solenoid valve 98 opens so that the whipped cream can flow through cream line 58′ into chamber 96. For the whipped cream to flow, pump 82 (shown in FIG. 4) must be energized at this time to move the whipped cream. The whipped cream enters chamber 96 under relatively high pressure (e.g., 30 psig). To bring in the desired amount of whipped cream, piston 92 must move down as the whipped cream enters chamber 96 to provide enough volume for the amount of the whipped cream desired. To maintain pressure in chamber 96 while it fills, piston 92 must be moved down at the correct rate, powered by stepper motor 66′. Pressure sensor 99 provides feedback such that piston 92 can be moved at a rate which maintains this pressure.

FIG. 5b shows device 20′ after chamber 96 has filled with the desired amount of unexpanded whipped cream. Piston 92 has traveled an amount that is roughly half of its final travel. At this point solenoid valve 98 is closed to seal off chamber 96 and prevent any more of the whipped cream from entering. Gate 94 is still in place also sealing chamber 96.

At this point, as shown in FIG. 5c, piston 92 has moved all the way down, expanding the volume of chamber 96 until the pressure is at ambient pressure (0 psig). If the whipped cream started at ^{˜}30 psig and 100% overrun, this will happen when the volume of the whipped cream has expanded to approximately double in volume so that its overrun is now 300%. The table below explains the expansion:

| | Unexpanded | Expanded |
|---|---|---|
| | Whipped Cream | Whipped Cream |
| Pressure | 30 psig (45 psia) | 0 psig (15 psia) = ⅓ |
| Chamber volume | 2 | 4 (=2x) |
| Cream volume | 1 | 1 |
| Gas volume | 1 | 3 (=3x) |
| Overrun | 100% | 300% |
| (gas vol/cream col) | | |

Once ambient pressure has been reached in chamber 96, gate 94 is opened providing a path for the expanded whipped cream to be dispensed. Piston 92 is then moved upward by stepper 66′ as illustrated in FIG. 5d to push the expanded whipped cream through passageway 25′ and out dispensing tap 24′ onto the top 26 of the beverage. Once all the expanded whipped cream has been dispensed, gate 94 is closed and chamber 98 is ready for another fill as shown in FIG. 5a.

Alternatively, by stopping piston 92 after reaching ambient pressure, as shown in FIG. 5c, but before gate 94 is opened, it is possible to hold and store the expanded whipped cream that is inside chamber 96. The expanded whipped cream can remain inside chamber 96 until a user needs to dispense the expanded whipped cream from machine 10. Accordingly, after dispensing the expanded whipped cream, machine 10 can fill chamber 96 with the whipped cream, as shown in FIG. 5b, and inflate the whipped cream to form the expanded whipped cream, as shown in FIG. 5c, so that machine 10 is ready for the next dispense at a future time.

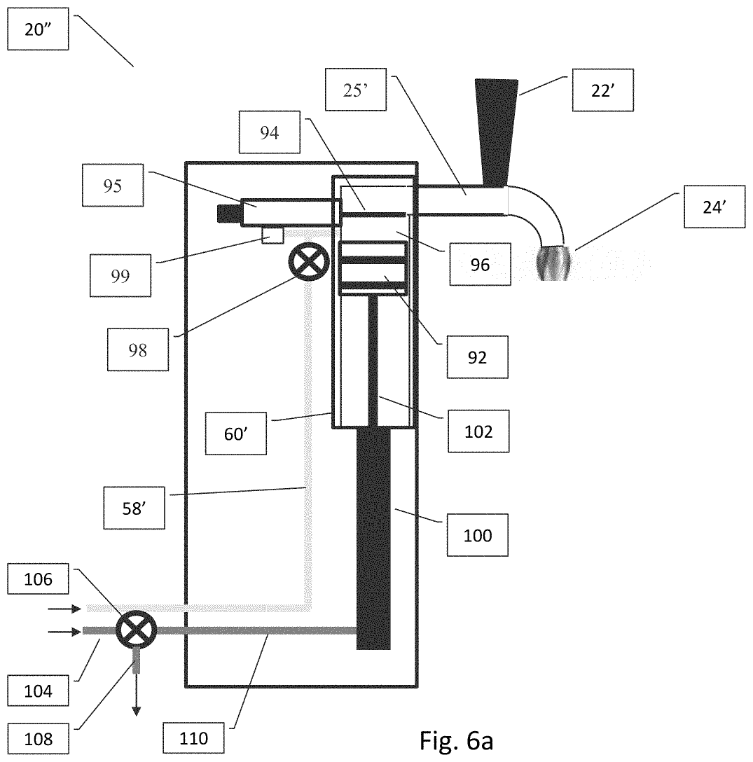

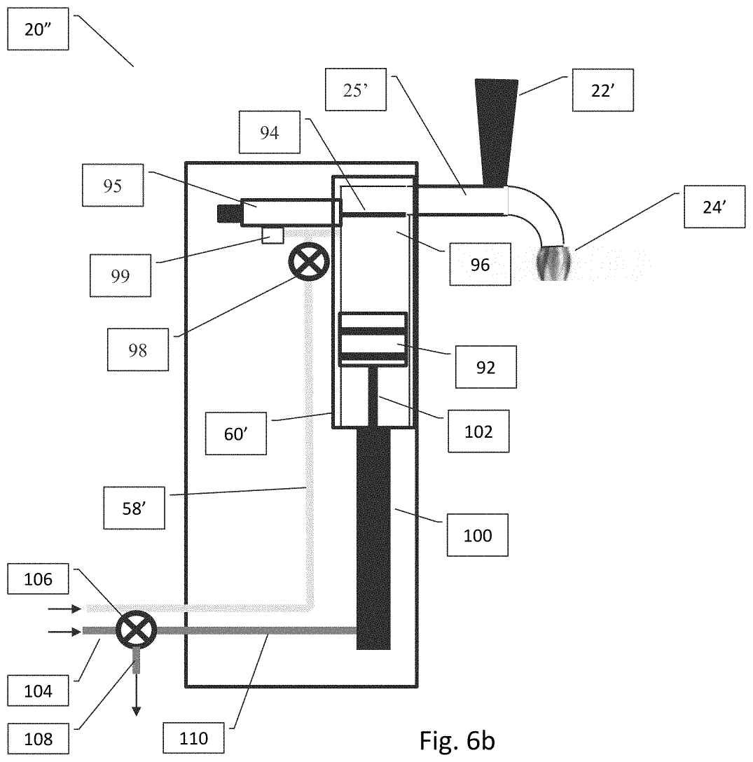

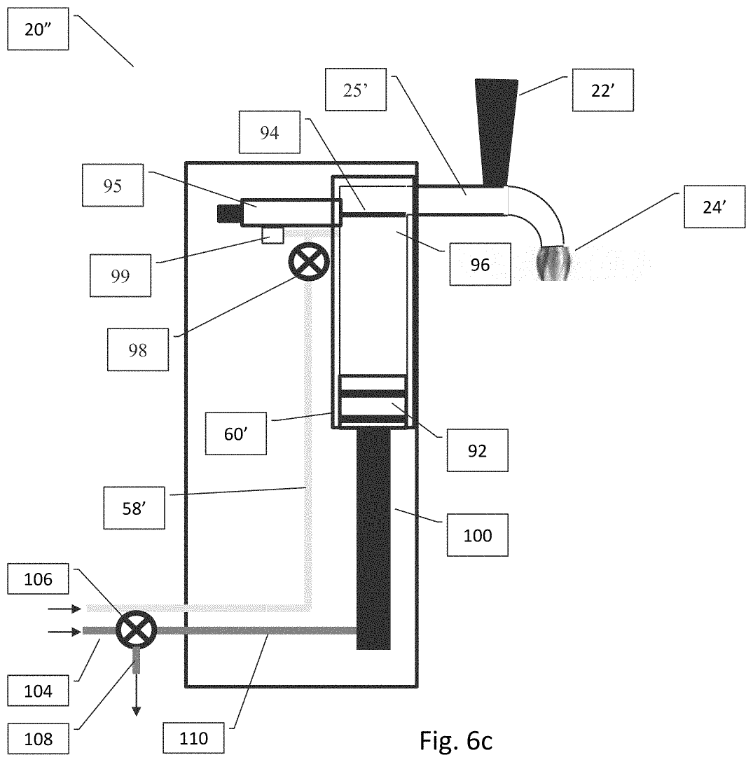

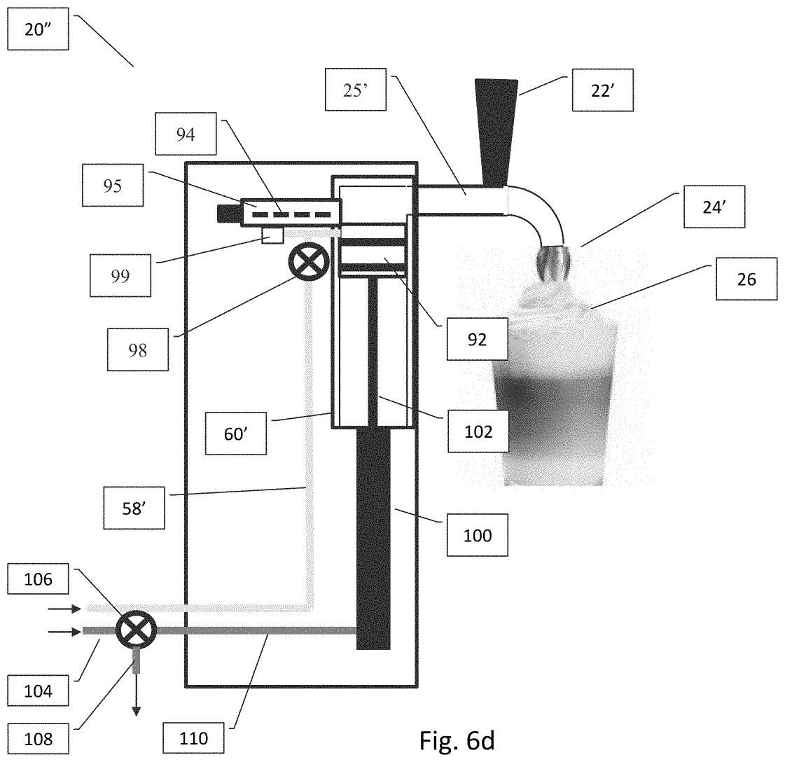

FIGS. 6a through 6d show a third embodiment of a dispensing tower/whipped cream expansion chamber 20″ of machine 10 illustrating its operation. Dispensing tower/whipped cream expansion chamber 20″ differs from dispensing tower/whipped cream expansion chamber 20′ in that stepper motor 66′ has been replaced by a pneumatic cylinder 100 to move piston 92. Pneumatic cylinder 100 is connected to piston 92 by shaft 102. Pneumatic cylinder 100 is pressurized through line 110 which is connected to a source of compressed air 104. The pressure of the gas entering through line 110 is modulated by valve 106. Valve 106 is also connected to ambient air through channel 108.

FIG. 6a shows dispensing tower/whipped cream expansion chamber 20″ prior to filling. Dispensing tower/whipped cream expansion chamber 20″ includes whipped cream line 58′, cylinder 60′, pneumatic cylinder 100, piston 92, gate 94, gate valve mechanism 95, whipped cream solenoid valve 98, pressure sensor 99 and pressure regulating valve 106. When dispensed, handle 22′ actuates pneumatic cylinder so that the expanded whipped cream will travel through passageway 25′ and exit through dispensing tap 24′.

In the beginning of a fill sequence, piston 92 is located next to gate 94 as shown in FIG. 6a. Solenoid valve 98 opens so that whipped cream can flow through cream line 58′ into chamber 96. For the whipped cream to flow, pump 82 (shown in FIG. 4) must be energized at this time to move the whipped cream. Whipped cream enters chamber 96 under relatively high pressure (e.g., 30 psig). To bring in the desired amount of whipped cream, piston 92 must move down as the whipped cream enters chamber 96 to provide enough volume for the amount of whipped cream desired. Movement of piston 92 is accomplished by relieving the pressure in pneumatic cylinder 100 through valve 106. Valve 106 relieves the pressure in the pneumatic cylinder, for example, by venting through channel 108, such that the pressure in chamber 96 is maintained while it fills. Pressure sensor 99 provides feedback such that pneumatic cylinder 100 is pressurized correctly.

FIG. 6b shows dispensing tower/whipped cream expansion chamber 20″ after chamber 96 has filled with the desired amount of the whipped cream. Piston 92 has traveled an amount that is roughly half of its final travel. At this point solenoid valve 98 is closed to seal off chamber 96 and prevent any more of the whipped cream from entering. Gate 94 is still in place also sealing chamber 96.

At this point, as shown in FIG. 6c, piston 92 has moved all the way down, expanding the volume of chamber 96 until the pressure is at ambient pressure (0 psig). If the whipped cream started at ^{˜}30 psig and 100% overrun, this will happen when the volume of the whipped cream has approximately doubled and its overrun is now 300% to form the expanded whipped cream. Once ambient pressure has been reached in chamber 96, gate 94 is opened providing a path for the expanded whipped cream to be dispensed. Piston 92 is then moved upward by pressurizing pneumatic cylinder 100 through line 110, as illustrated in FIG. 6d to push the expanded whipped cream through passageway 25′ and out dispensing tap 24′ onto the top 26 of the beverage. Once all the expanded whipped cream has been dispensed, gate 94 is closed and chamber 96 is ready for another fill as shown in FIG. 6a.

Alternatively, by stopping piston 92 after reaching ambient pressure, as shown in FIG. 6c, but before gate 94 is opened, it is possible to hold and store the expanded whipped cream that is inside chamber 96. The expanded whipped cream can remain inside chamber 96 until a user needs to dispense the expanded whipped cream from machine 10. Accordingly, after dispensing the expanded whipped cream, machine 10 can fill chamber 96 with the whipped cream, as shown in FIG. 6b, and inflate the whipped cream to form the expanded whipped cream, as shown in FIG. 6c, so that machine 10 is ready for the next dispense at a future time.

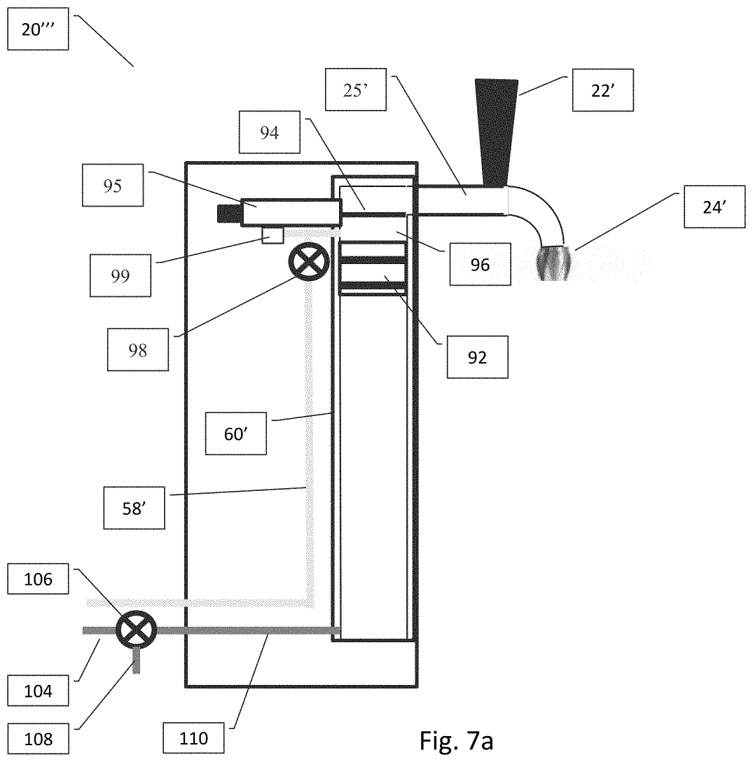

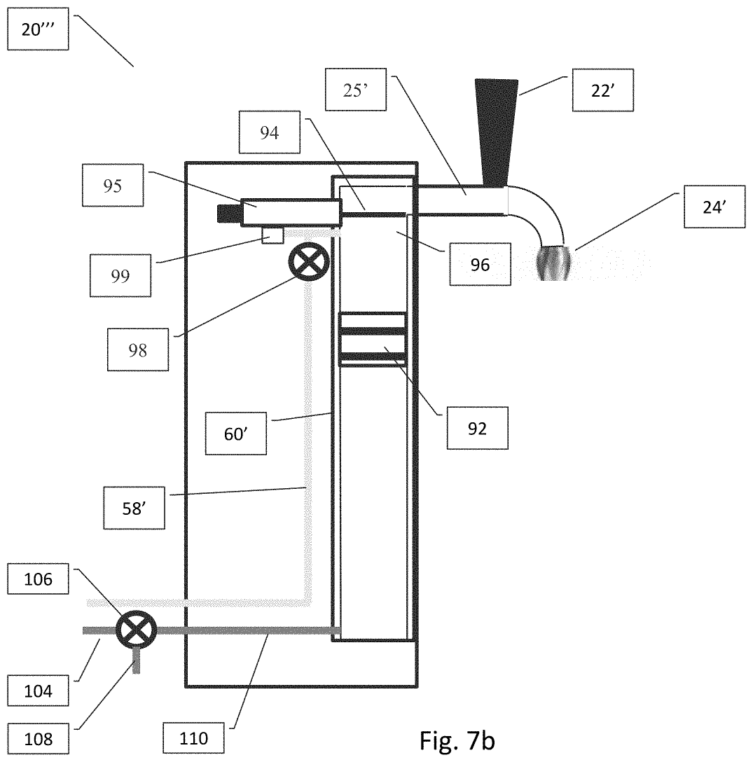

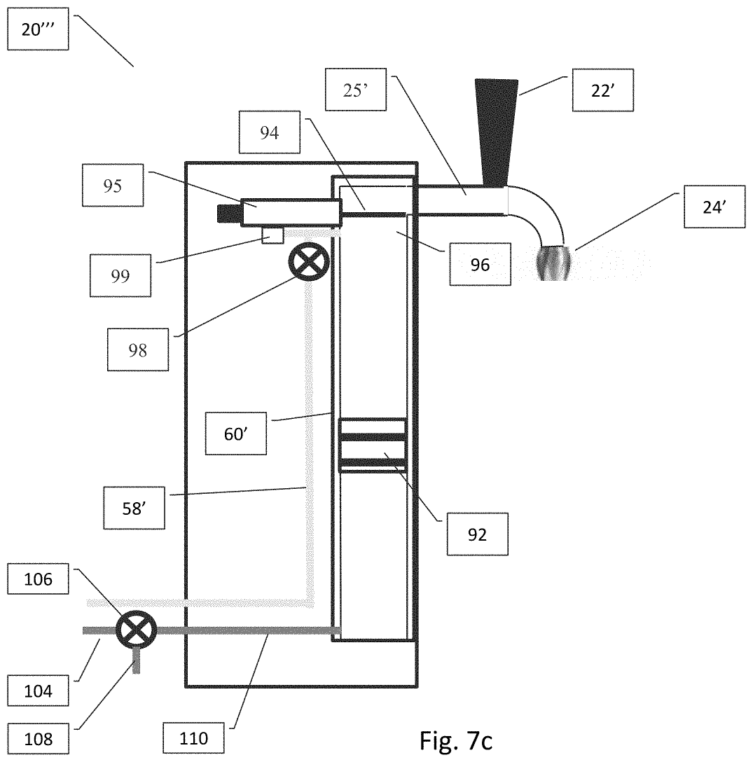

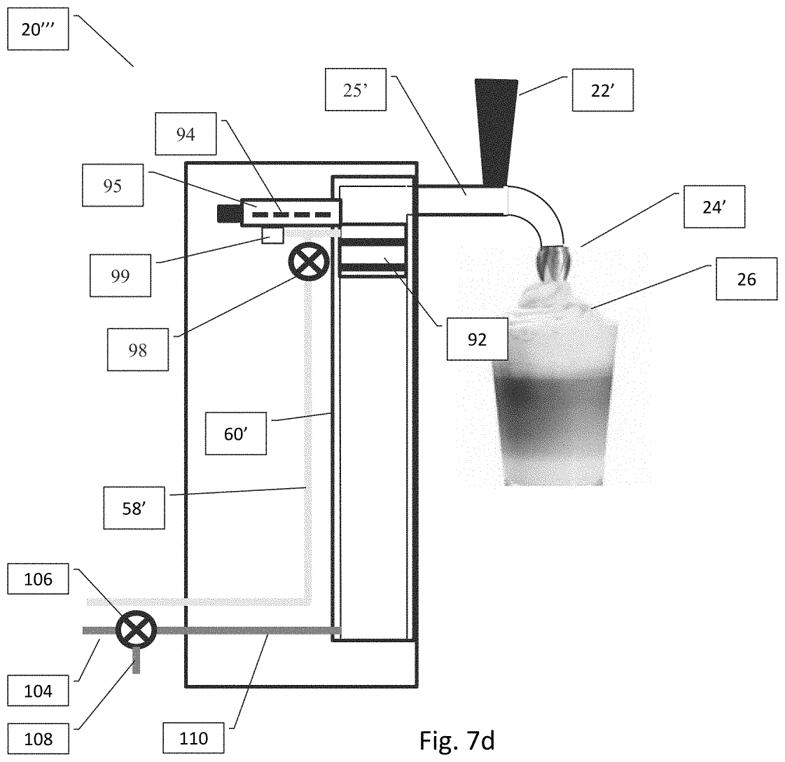

FIGS. 7a through 7d show a fourth embodiment of a dispensing tower/whipped cream expansion chamber 20′″ illustrating its operation. Dispensing tower/whipped cream expansion chamber 20′″ differs from dispensing tower/whipped cream expansion chamber 20″ in that pneumatic cylinder 100 has been eliminated and air pressure is applied directly to cylinder 60′ to move piston 92. So instead of pressurizing pneumatic cylinder 100, cylinder 60′ is pressurized through line 110 which is connected to a source of compressed air 104. The pressure of the gas entering through line 110 is modulated by valve 106. Valve 106 is also connected to ambient air through channel 108.

FIG. 7a shows chamber 96 prior to filling. Dispensing tower/whipped cream expansion chamber 20′″ includes whipped cream line 58′, cylinder 60′, piston 92, gate 94, gate valve mechanism 95, whipped cream solenoid valve 98, pressure sensor 99 and pressure regulating valve 106. When dispensed, handle 22′ actuates source of compressed air 104 to move piston 92 so that the expanded whipped cream will travel through passageway 25′ and exit through dispensing tap 24′.

In the beginning of a fill sequence, piston 92 is located next to gate 94 as shown in FIG. 7a. Solenoid valve 98 opens so that the whipped cream can flow through cream line 58′ into chamber 96. For the whipped cream to flow, pump 82 (shown in FIG. 4) must be energized at this time to move the whipped cream. The whipped cream enters chamber 96 under relatively high pressure (e.g., 30 psig). To bring in the desired amount of whipped cream, piston 92 must move down as the whipped cream enters chamber 96 to provide enough volume for the amount of whipped cream desired. Movement of piston 92 is accomplished by relieving the pressure in cylinder 60′ through valve 106. Valve 106 relieves the pressure, for example, by venting through channel 108, in cylinder 60 such that the pressure in chamber 96 is maintained while it fills. Pressure sensor 99 provides feedback such that cylinder 60 is pressurized correctly.

FIG. 7b shows dispensing tower/whipped cream expansion chamber 20′″ after chamber 96 has filled with the desired amount of the whipped cream. Piston 92 has traveled an amount that is roughly half of its final travel. At this point solenoid valve 98 is closed to seal off chamber 96 and prevent any more whipped cream from entering. Gate 94 is still in place also sealing chamber 96.

At this point, as shown in FIG. 7c, piston 92 has moved all the way down, expanding the volume of chamber 96 until the pressure is at ambient pressure (0 psig). If the whipped cream started at ^{˜}30 psig and 100% overrun, this will happen when the volume of the whipped cream has approximately doubled and its overrun is now 300% to form expanded whipped cream. Once ambient pressure has been reached in chamber 96, gate 94 is opened providing a path for the expanded whipped cream to be dispensed. Piston 92 is then moved upward by pressurizing cylinder 60′ through line 110, as illustrated in FIG. 7d, to push the expanded whipped cream through passageway 25′ and out dispensing tap 24′ onto the top 26 of the beverage. Once all the expanded whipped cream has been dispensed, gate 94 is closed and the expansion chamber is ready for another fill as shown in FIG. 7a.

Alternatively, by stopping piston 92 after reaching ambient pressure, as shown in FIG. 7c, but before gate 94 is opened, it is possible to hold and store the expanded whipped cream that is inside chamber 96. The expanded whipped cream can remain inside chamber 96 until a user needs to dispense the expanded whipped cream from machine 10. Accordingly, after dispensing the expanded whipped cream, machine 10 can fill chamber 96 with the whipped cream and gas mixture, as shown in FIG. 7b, and inflate the whipped cream and gas mixture to form the expanded whipped cream, as shown in FIG. 7c, so that machine 10 is ready for the next dispense at a future time.

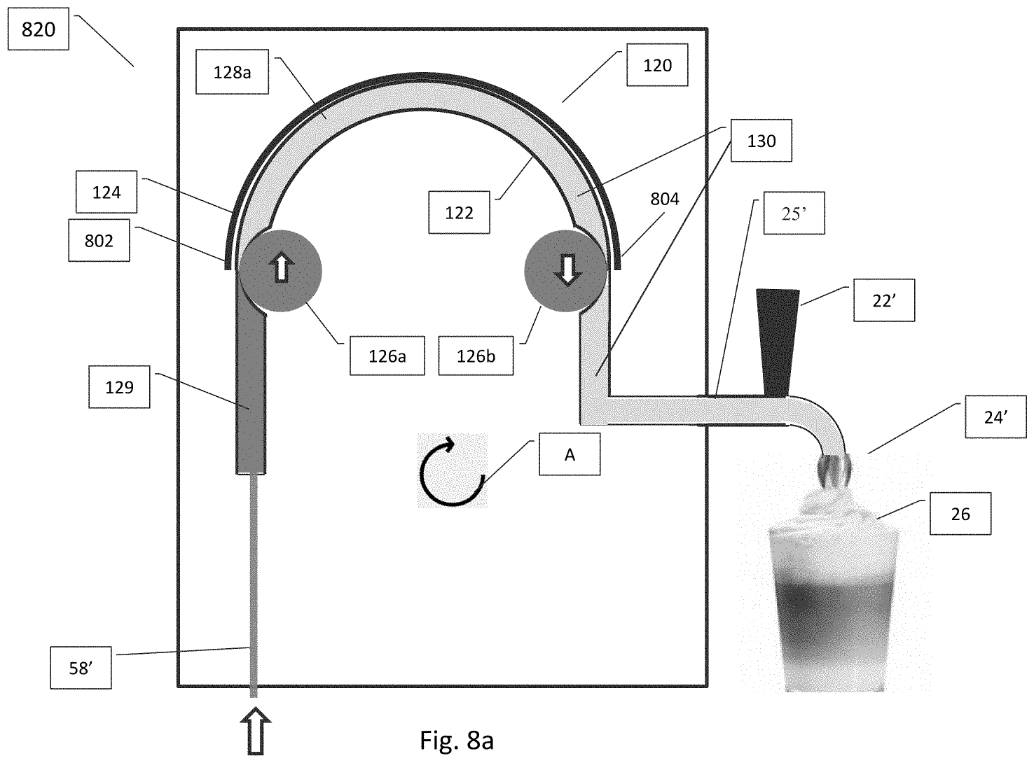

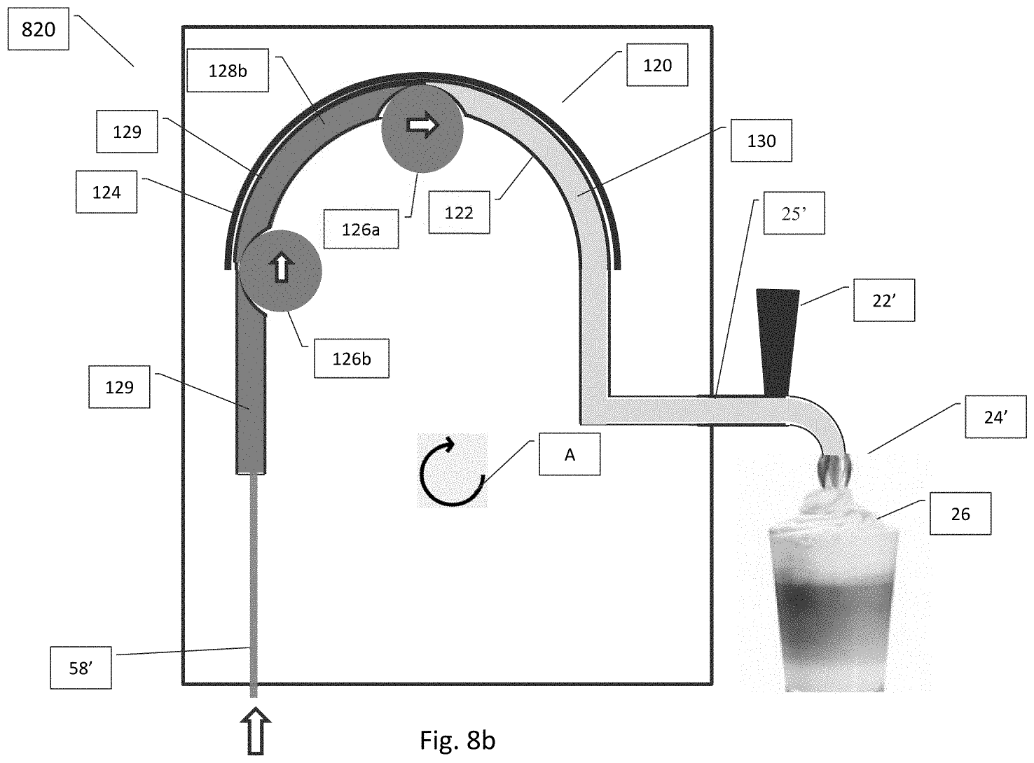

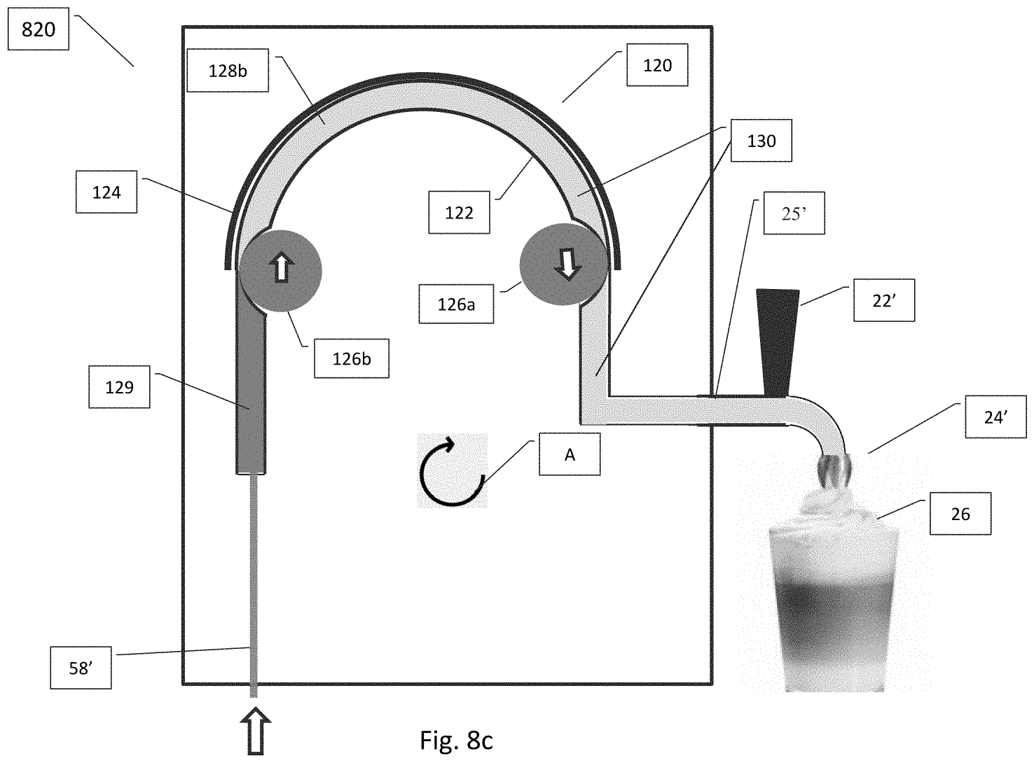

FIGS. 8a through 8c show a fifth embodiment of a dispensing tower/whipped cream expansion chamber 820. Dispensing tower/whipped cream expansion chamber 820 has a construction that is similar to a peristaltic pump including a peristaltic expander 120. Peristaltic expander 120 includes tubing 122, a wall 124 and rollers 126a and 126b. Tubing 122 is pliable, for example, silicone tubing. Tubing 122 is connected to cream line 58′ on a first end and to dispensing tap 24′ on a second opposite end. Tubing 122 has a passage formed by an outer wall allowing the whipped cream to flow from line 58′ to dispensing tap 24′. Tubing 122 is deformable so that when a compressing force is applied to the wall of tubing 122, then tubing 122 can be compressed to shrink or close off the passage of tubing 122, and when the compressing force is released, then a resiliency of the wall of tubing 122 opens the passage of tubing 122. A portion of tubing 122 is positioned adjacent wall 124. Wall 124 is a curved shape, for example, a hemispherical shape.

Rollers 126a and 126b are independently operated to rotate inside wall 124. Rollers 126a and 126b can be independently operated by a controller, for example, a controller having a processor and a memory. Rollers 126a and 126b each apply a compressing force on tubing 122 compressing or pinching tubing 122 between rollers 126a, 126b and wall 124 when rollers 126a and 126b are positioned adjacent wall 124. Roller 126a applies the compressing force deforming tubing 122 to close the passage of tubing 122 at roller 126a and roller 126b applies the compressing force deforming tubing 122 to close the passage of tubing at roller 126b to form a sealed container 128 in a segment of tubing 122 between roller 126a and 126b. Rollers 126a and 126b each pinch tubing 122 against wall 124 to turn tubing 122 into a continuous series of sealed containers 128 between rollers 126a and 126b through which the whipped cream will flow. For example, roller 126a is connected to a first motor and roller 126b is connected to a second motor so that the first motor rotates roller 126a in a clockwise direction A independently from roller 126b and the second motor rotates roller 126b in clockwise direction A independently from roller 126a to move each of rollers 126a, 126b along a length of wall 124 from a first side 802 to a second side 804 of wall 124. When rollers 126a, 126b move from first side 802 of wall 124 to second side 802, tubing 122 is compressed against wall 124 to close the passage through tubing 122 at each of rollers 126a, 126b and when the compressing force of each of rollers 126a, 126b is released, then the resiliency of the wall of tubing 122 opens the passage of tubing 122 that is out of contact with rollers 126a, 126b. After each of rollers 126a, 126b move from first side 802 of wall 124 to second side 802, then each of rollers 126a, 126b can move from second side 804 of wall 124 to first side 802 of wall 124 while out of contact with tubing 122. In a conventional peristaltic pump, the pinching rollers have a fixed separation so that the size of the containers does not change, for example, movement of both of rollers 126a, 126b at the same speed while both rollers 126a, 126b are adjacent wall 124 moves container 128 while maintaining the size of container 128. In peristaltic expander 120, rollers 126a and 126b are independently driven so that the distance between them, and the size of containers 128, can vary as the whipped cream flows through expander 120. It is this variable container size which allows the whipped cream to be expanded (from an elevated pressure of around 30 psig down to approximately ambient pressure (0 psig)) as it flows through expander 120. For example, when both rollers 126a, 126b are adjacent wall 124, movement of one of rollers 126a,126b while the other of rollers 126a, 126b is stationary or one of rollers 126a, 126b is moved at a faster speed while the other of rollers 126a, 126b is moved at a slower speed changes the size of container 128.

Peristaltic expander 120 is designed to operate in a continuous fashion. Because of this, FIG. 8a shows peristaltic expander 120 during operation when already filled with whipped cream with roller 126a at a 9 o'clock position of expander 120 and roller 126b at a 3 o'clock position so that roller 126a applies a compressing force to tubing 122 at the 9 o'clock position and roller 126b applies a compressing force to tubing 122 at the 3 o'clock position to form container 128a between rollers 126a and 126b where tubing 122 is free from contacting rollers 126a, 126b so that the passage of tubing 122 is open between rollers 126a and 126b. The whipped cream 129 that is pressurized to 30 psig entered dispensing tower/whipped cream expansion chamber 820 and peristaltic expander 120 through line 58′ and filled tubing 122 upstream of roller 126a where tubing 122 is free from contacting rollers 126a, 126b. At this point, expanded whipped cream 130 fills container 128a and the remainder of the whipped cream path that is downstream of roller 126b where tubing 122 is free from contacting rollers 126a, 126b. Expanded whipped cream 130 is at ambient pressure (0 psig). Although not visible since this is a static figure, rollers 126a and 126b are both in continuous motion rotating in a clockwise direction A pinching tubing 122 against wall 124 at each of rollers 126a, 126b while rollers 126a, 126b are adjacent wall 124 and the passage of tubing is open where tubing 122 is free from contacting rollers 126a, 126b.

FIG. 8b shows the peristaltic expander 120 with rollers 126a, 126b having rotated in clockwise direction A from their positions shown in FIG. 8a to their positions shown in FIG. 8b. Roller 126a has rotated 90 degrees in clockwise direction A from the 9 o'clock position shown in FIG. 8a to a 12 o'clock position shown in FIG. 8b, allowing the compressing force of roller 126a to be released at the 9 o'clock position opening the passage in tubing 122 so that whipped cream 129 from line 58′ fills tubing 122 to the 12 o'clock position shown in FIG. 8b where roller 126a applies a compressing force to tubing 122 prior to roller 126b moving to the position of roller 126b shown in FIG. 8b. Simultaneously roller 126b has rotated 180 degrees from the 3 o'clock position shown in FIG. 8a in clockwise direction A, to a position out of contact with tubing 122 not shown, to the 9 o'clock position shown in FIG. 8b, where roller 126b applies a compressing force sealing off a section 128b of tube 122 with whipped cream 129 inside it while allowing the compressing force of roller 126b to be released at the 3 o'clock position opening the passage in tubing 122 so that expanded whipped cream 130 can move to dispensing tap 24′. Note that rollers 126a and 126b have moved different amounts from their positions in FIG. 8a to their positions in FIG. 8b, made possible by the fact that they are controlled independently so they can move at different rates. Because roller 126b has rotated past the 3 o'clock position that was shown in FIG. 8a, expanded whipped cream 130 that was in container 128a is now free to move towards dispensing tap 24′ pushed by the clockwise motion of roller 126a rotating 90 degrees clockwise from the 9 o'clock position shown in FIG. 8a to the 12 o'clock position shown in FIG. 8b while a section of tubing 122 between roller 126a and dispensing tap 24′ is out of contact with both of rollers 126a, 126b. A compressing force is applied to tubing 122 at a location where roller 126a contacts tubing 122 as roller 126a moves along a length of tubing 122 to push expanded whipped cream 130 to dispensing tap 24′ from the 9 o'clock position to the 12 o'clock position.

FIG. 8c shows expander 120 after roller 126a has moved in clockwise direction A from the 12 o'clock position shown in FIG. 8b to the 3 o'clock position shown in FIG. 8c allowing the compressing force of roller 126a to be released from tubing 122 at the 12 o'clock position and applying a compressing force to tubing 122 at the 3 o'clock position while roller 126b is maintained in the 9 o'clock position shown in FIG. 8b applying a compressing force to tubing 122 at the 9 o'clock position opening the passage in tubing 122 so that the size of container 128b formed by the section of tubing between rollers 126a and 126b doubles in length and volume. This doubling in volume of container 128b by moving rollers 126a and 126b further apart is sufficient to cause whipped cream 129 at 30 psig to drop until expanded whipped cream 130 is formed having a pressure of 0 psig and its volume has doubled. As explained before, this causes whipped cream 129 to expand to expanded whipped cream 130 having an overrun of 300%. The motion of roller 126a from the 12 o'clock position shown in FIG. 8b to the 3 o'clock position shown in FIG. 8c has also applied a compressing force to tubing 122 at a location where roller 126a contacts tubing 122 as roller 126a moves along a length of tubing 122 to push expanded whipped cream 130 downstream of roller 126a to dispensing tap 24′ from the 12 o'clock position to the 3 o'clock position toward and out of dispense tap 24′ to its destination 26 on top of a beverage. As can be seen by comparing FIGS. 8a and 8c, the two figures are identical except that rollers 126a and 126b have swapped positions. Thus the expansion process continues from FIG. 8c just as it did from FIG. 8a. In particular, roller 126b moves in clockwise direction A 90 degrees from the 9 o'clock position shown in FIG. 8c to the 12 o'clock position that is the same as the position of roller 126a shown in FIG. 8b allowing the compressing force of roller 126b to be released at the 9 o'clock position opening the passage in tubing 122 so that whipped cream 129 from line 58′ fills tubing 122 to the 12 o'clock position of roller 126b prior to roller 126a moving to the position of roller 126a shown in FIG. 8a. Simultaneously roller 126a has rotated 180 degrees from the 3 o'clock position shown in FIG. 8c in clockwise direction A, to a position out of contact with tubing 122 not shown, to the 9 o'clock position shown in FIG. 8a, sealing off a section 128 of tube 122 with whipped cream 129 inside it while allowing the compressing force of roller 126a to be released at the 3 o'clock position opening the passage in tubing 122 so that expanded whipped cream 130 can move to dispensing tap 24′. Because roller 126a has rotated past the 3 o'clock position, expanded whipped cream 130 that was in container 128b is now free to move towards dispensing tap 24′ pushed by the clockwise motion of roller 126b rotating 90 degrees clockwise from the 9 o'clock position to the 12 o'clock position while a section of tubing 122 between roller 126b and dispensing tap 24′ is out of contact with both of rollers 126a, 126b. A compressing force is applied to tubing 122 at a location where roller 126b contacts tubing 122 as roller 126b moves along a length of tubing 122 to push expanded whipped cream 130 to dispensing tap 24′ from the 9 o'clock position to the 12 o'clock position.

FIG. 8a shows expander 120 after roller 126b has moved in clockwise direction A from the 12 o'clock position to the 3 o'clock position allowing the compressing force of roller 126b to be released from tubing 122 at the 12 o'clock position and applying a compressing force to tubing 122 at the 3 o'clock position while roller 126a is maintained in the 9 o'clock position shown in FIG. 8a applying a compressing force to tubing 122 at the 9 o'clock position opening the passage in tubing 122 so that the size of container 128 formed by the section of tubing between rollers 126a and 126b doubles in length and volume. This doubling in volume of container 128 by moving rollers 126a and 126b further apart is sufficient to cause whipped cream 129 at 30 psig to drop until expanded whipped cream 130 is formed having a pressure of 0 psig and its volume has doubled. The motion of roller 126b from the 12 o'clock position to the 3 o'clock position has also applied a compressing force to tubing 122 at a location where roller 126b contacts tubing 122 as roller 126b moves along a length of tubing 122 to push expanded whipped cream 130 downstream of roller 126b to dispensing tap 24′ from the 12 o'clock position to the 3 o'clock position toward and out of dispense tap 24′ to its destination 26 on top of a beverage. Rotation can continue so that rollers 126a, 126b repeat the 9 o'clock, 12 o'clock and 3 o'clock positions shown in FIGS. 8a-8c as described herein during operation of peristaltic expander 120.

The peristaltic expander 120 will create and dispense expanded whipped cream as long as it needs to as called for by the position of tap handle 22′. The rollers 126a and 126b can stop at any point when whipped cream is no longer called for so that operation of peristaltic expander 120 can be selectively paused or stopped, and, then, selectively restarted. Because the interior of dispensing tower/whipped cream expansion chamber 820 is refrigerated, the whipped cream (both before and after expansion) will simply stay properly preserved inside tubing 122 until it is called for. Unlike whipped cream made with nitrous oxide, mechanically whipped whipped cream does not “melt”, but rather will stay unchanged. For proper handling of milk products it will be necessary to purge out the remaining whipped cream on a periodic basis (e.g., daily). The plumbing required to do this is not shown.

This fifth embodiment of the dispensing tower/whipped cream expansion chamber 820 is superior to the other embodiments in two significant ways: 1. Peristaltic expander 820 produces whipped cream in a continuous stream, dispensing as much or as little whipped cream as is called for without any hesitation in the dispense stream. 2. Because the whipped cream only comes into contact with the inside of pliable tubing 122, peristaltic expander 820 can easily be sanitized using a clean-in-place operation with no disassembly required. 3. Tubing 122 can also be easily replace as needed due to wear caused by extended operation.

It should be noted that mixing portion 11 could be combined with any of dispensing tower/whipped cream expansion chamber 20, 20′, 20″, 20′″, 820 shown in FIG. 5a through 8c, likewise mixing portion 11′ could also be combined with any of dispensing tower/whipped cream expansion chamber 20, 20′, 20″, 20″, 820. Similarly, other mixing devices could be combined with other expansion devices to achieve high-overrun whipped cream as long as the mixing device creates a whipped cream+gas emulsion of 75% to 200% overrun at an elevated pressure and the expansion device is capable of reducing the pressure of the cream emulsion by a factor of two or more to end up at ambient pressure.

1. A whipped cream machine comprising:
a source of whipping cream;
a source of gas;
a mixing portion connected to the source of whipping cream and the source of gas to form a whipping cream and gas mixture at an elevated pressure that is a whipped cream;
an expansion device to relieve the pressure and expand the gas in the whipped cream to form expanded whipped cream that has been expanded to the desired overrun; and
a dispenser to dispense the expanded whipped cream.

2. The whipped cream machine of claim 1, wherein the mixing portion has a venturi and a pump that creates a flow of whipping cream from the source of whipping cream through the venturi.

3. The whipped cream machine of claim 1, wherein the expansion device has an upper piston spaced from a lower piston forming a chamber therebetween that receives the whipped cream to partially fill the chamber, and wherein the upper piston and/or the lower piston move to uncover a vent lowering a pressure in the chamber so that the whipped cream expands to form the expanded whipped cream.

4. The whipped cream machine of claim 1, wherein the expansion device has a piston spaced from a gate that forms a chamber therebetween that receives the whipped cream, and wherein the piston is moved away from the gate by a stepper motor enlarging the size of the chamber so that the whipped cream expands to form the expanded whipped cream.

5. The whipped cream machine of claim 1, wherein the expansion device has a piston spaced from a gate that forms a chamber therebetween that receives the whipped cream, and wherein the piston is moved away from the gate by a pneumatic cylinder enlarging the size of the chamber so that the whipped cream expands to form the expanded whipped cream.

6. The whipped cream machine of claim 1, wherein the expansion device has a piston spaced from a gate that forms a chamber therebetween that receives the whipped cream, and wherein the piston is moved away from the gate by relieving a pressure of a compressed gas in a cylinder that houses the piston enlarging the size of the chamber so that the whipped cream expands to form the expanded whipped cream.

7. The whipped cream machine of claim 1, wherein the dispenser has a passageway and an orifice that is ¼″ or larger so not to cause gas that form bubbles inside of the expanded whipped cream to burst.

8. A whipped cream machine comprising:
a source of a whipped cream; and
a peristaltic expander to relieve pressure and expand gas in the whipped cream to form expanded whipped cream.

9. The whipped cream machine of claim 8, wherein the peristaltic expander has a plurality of rollers, a wall and pliable tubing.

10. The whipped cream machine of claim 9, wherein the plurality of rollers are independently controlled to pinch the pliable tubing against the wall to form a container containing a portion of the whipped cream therebetween.

11. The whipped cream machine of claim 10, wherein the plurality of rollers are movable away from each other enlarging a size of the container so that the portion of the whipped cream expands to form the expanded whipped cream.

12. The whipped cream machine of claim 9, wherein the whipped cream has a first portion that is received in the pliable tubing upstream of a first roller of the plurality of rollers that is in a first position adjacent the wall, and wherein a second roller of the plurality of rollers is moved to a second position upstream of the first roller against the wall to form a first container.

13. The whipped cream machine of claim 12, wherein the first roller is moved to a third position adjacent the wall from the first position to be further apart from the second roller.

14. The whipped cream machine of claim 13, wherein the movement of the first roller from the first position to the third position causes a flow of a portion of the expanded whipped cream downstream of the first roller out of the dispenser.

15. The whipped cream machine of claim 14, wherein the second roller is moved to the first position so that a second portion of the whipped cream is received in the pliable tubing upstream of the second roller.

16. The whipped cream machine of claim 15, wherein the first roller is moved to the second position upstream of the second roller against the wall to form a second container of the plurality of containers.

17. The whipped cream machine of claim 16, wherein the second roller is moved to the third position from the first position to be further apart from the first roller.

18. The whipped cream machine of claim 17, wherein the movement of the second roller from the first position to the third position causes a flow of another portion of the expanded whipped cream downstream of the second roller out of the dispenser.

19. The whipped cream machine of claim 18, wherein the first roller and the second roller alternately repeat the first, second and third positions to dispense the expanded whip cream.

20. A method of expanding whipped cream comprising:
providing a source of whipped cream having a first pressure; and
reducing the pressure in the whipped cream to form expanded whipped cream at a second pressure that is lower than the first pressure.
